(19) United States
(12) Patent Application Publication
(10) Pub. No.: US 2013/0107783 A1
(43) Pub. Date: May 2, 2013

(54) Intelligent Hot Spot and Tethering

(71) Applicant: Venson M. Shaw, Kirkland, WA (US)

(72) Inventor: Venson M. Shaw, Kirkland, WA (US)

(73) Assignee: AT&T Intellectual Property I, L.P, Reno, NV (US)

(21) Appl. No.: 13/281,708

(22) Filed: Oct. 26, 2011

(51) Int. Cl. H04W 72/06; H04W 4/06; H04W 72/10

(52) U.S. Cl. 370/312; 370/329

(57) ABSTRACT

A hot spot may provide access to a network using a variety of criteria. Priority may be determined for devices requesting access to the network. A ranking for devices requesting access to the network based on usage amount and currency of usage may be used. An auction may be held to determine the devices that are provided access to the network. A mobile device may serve as a gateway to a network for devices tethered to the mobile device. The network may configure a connection with the mobile device using parameters determined with the knowledge that the connection will be used for a tethered device.

### TECHNICAL FIELD

The technical field generally relates to wireless communications and more specifically relates to hot spots and tethering systems for connecting a mobile device to a wireless network.

### BACKGROUND

In current wireless networks, connectivity points designed to service small numbers of users, often in private residences or businesses, are known as “hot spots.” While Wi-Fi hot spots have been common for some time allowing users to connect to the Internet, hot spots are now available for other wireless technologies, such as cellular hot spots that allow a user to connect to a cellular network. Some current hot spots allow any device that has the proper security configuration to connect to them and communicate with the network. Others have no security measures configured and are therefore provide public access to their network for any device capable of communicating with the hot spot.

Mobile devices that are configured to communicate with a wireless network may also be configured to allow other devices to communicate with the wireless network via the mobile device. This is often called “tethering.” Current devices capable of providing tethering services simply provide a conduit for the traffic of the tethered device. The network for which the tethering mobile device facilitates communication for the tethered device does not have knowledge of the tethered device. There are no configurations in the mobile device or the network that can be used to optimize or customize the connection of the mobile device based on the tethering of the tethered device to the mobile device.

### SUMMARY

Systems, methods, and devices are disclosed for operating a hot spot by receiving requests for access to network from wireless devices and determining whether and how to provide access to the network using a variety of means and methods. In an embodiment, a hot spot may conduct an auction to determine the devices that are permitted to access the network via the hot spot. In another embodiment, the hot spot may determine a priority of the devices and provide access based on the priority. In another embodiment, the hot spot may determine the devices that are permitted to access the network based on how often and/or how much the devices have connected to the hot spot for purposes of accessing the network. The hot spot may perform such determination for each request for access received, or may do so when the hot spot is nearing maximum capacity. The hot spot may use a threshold of bandwidth or number of devices serviced to determine whether it is at capacity.

A mobile device may operate as a gateway to a wireless network for tethered devices. The wireless network may receive device-specific information about the tethered devices from the mobile device. This information may include a device identifier, a user identifier, and/or a device type. The network may use this information to determine parameters for establishing a connection with the mobile device or altering an established connection with the mobile device. Such parameters may be configured by the network in response to user provision of tethered device information, or the parameters may be set by the network and used for identified types of devices. Such parameters may be designed to facilitate the connection for the tethered device. These and other aspects of the present disclosure are described in more detail herein.

### BRIEF DESCRIPTION OF THE DRAWINGS

The following detailed description of preferred embodiments is better understood when read in conjunction with the appended drawings. For the purposes of illustration, there is shown in the drawings exemplary embodiments; however, the subject matter is not limited to the specific elements and instrumentalities disclosed. In the drawings:

FIG. 1A is a system diagram of an example communications system in which one or more disclosed embodiments may be implemented.

FIG. 1B is a system diagram of an example mobile device (also referred to as a wireless transmit/receive unit (WTRU) and/or as user equipment (UE)) that may be used within the communications system illustrated in FIG. 1A.

FIG. 1C is a system diagram of an example radio access network and an example core network that may be used within the communications system illustrated in FIG. 1A.

FIG. 2 illustrates a non-limiting exemplary network configuration according to an intelligent hot spot and tethering embodiment.

FIG. 3 illustrates a non-limiting exemplary method of implementing an intelligent hot spot and/or intelligent tethering using a mobile device.

FIG. 4 illustrates another non-limiting exemplary method of implementing an intelligent hot spot and/or intelligent tethering using a mobile device.

FIG. 5 illustrates a non-limiting exemplary method of implementing an intelligent hot spot and/or intelligent tethering using a mobile device.

FIG. 6 illustrates another non-limiting exemplary network configuration according to an intelligent hot spot and tethering embodiment.

FIG. 7 illustrates another non-limiting exemplary method of implementing an intelligent hot spot and/or intelligent tethering using a mobile device.

FIG. 8 is a block diagram of a non-limiting exemplary mobile device in which intelligent hot spot and tethering may be implemented.

FIG. 9 is a block diagram of a non-limiting exemplary processor in which intelligent hot spot and tethering may be implemented.

FIG. 10 is a block diagram of a non-limiting exemplary packet-based mobile cellular network environment, such as a GPRS network, in which intelligent hot spot and tethering may be implemented.

FIG. 11 illustrates a non-limiting exemplary architecture of a typical GPRS network, segmented into four groups, in which intelligent hot spot and tethering may be implemented.

FIG. 12 illustrates a non-limiting alternate block diagram of an exemplary GSM/GPRS/IP multimedia network architecture in which intelligent hot spot and tethering may be implemented.

### DETAILED DESCRIPTION OF ILLUSTRATIVE EMBODIMENTS

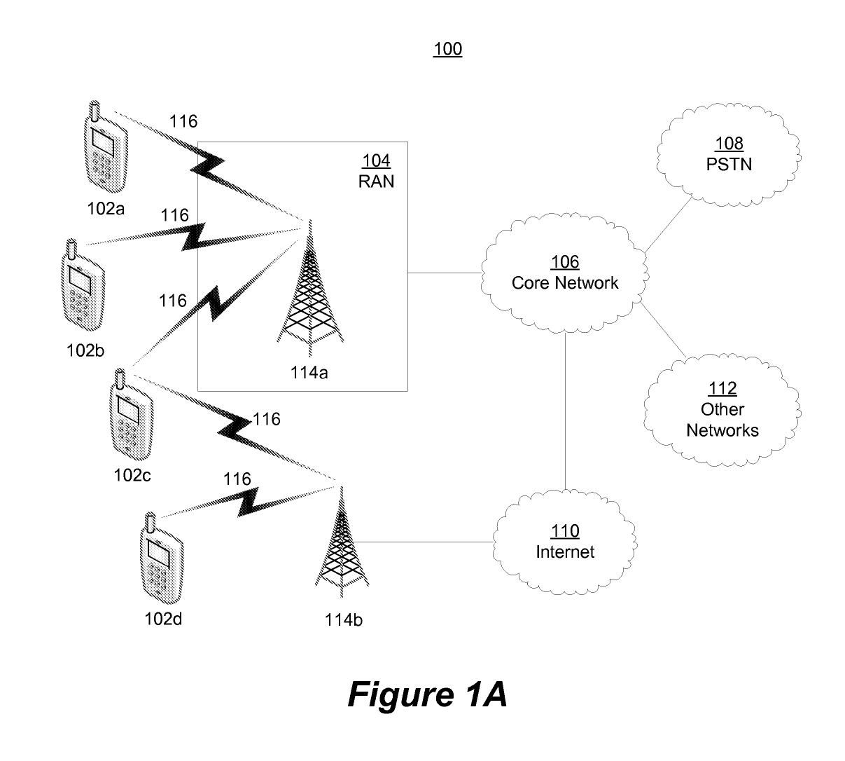

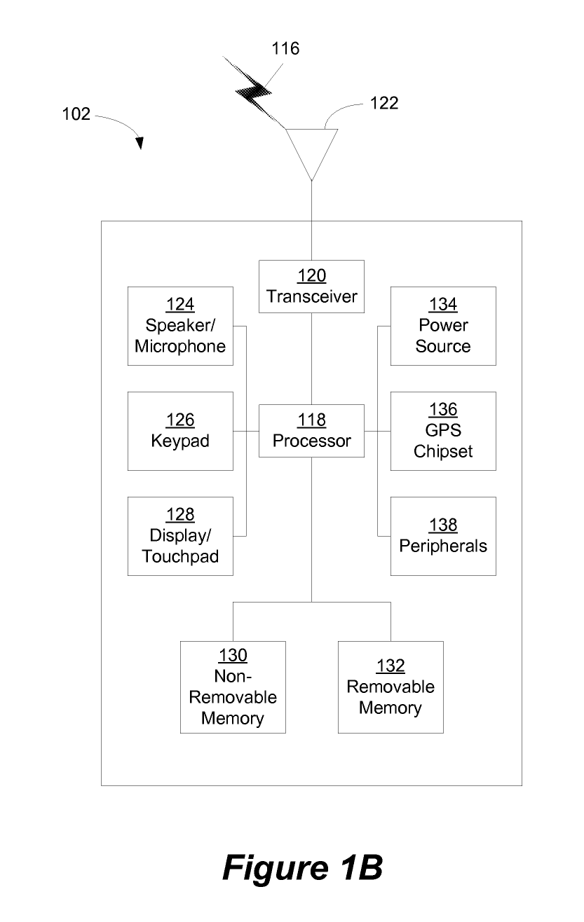

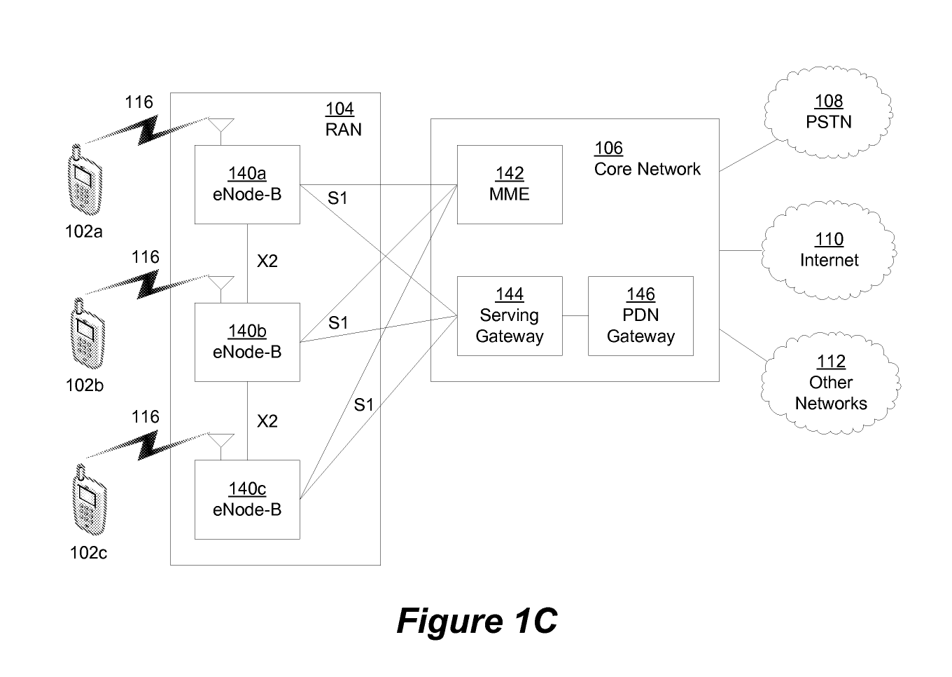

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier carrier FDMA (SC-FDMA), and the like. A communications system such as that shown in FIG. 1A may also be referred to herein as a network.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a mobile device, a fixed or mobile subscriber unit, a pager, a cellular telephone, a personal digital assistant (PDA), a smartphone, a laptop, a netbook, a personal computer, a wireless sensor, consumer electronics, home electronics, automobile electronics, medical electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA) that may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. Processor 118 may include circuitry and other components that enable processor 118 to perform any of the functions and methods described herein. Such circuitry and other components may also enable processor 118 to communicate and/or interact with other devices and components, for example any other component of device of WTRU 102, in such a manner as to enable processor 118 and such other devices and/or components to perform any of the disclosed functions and methods. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, and 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, and 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway or entity (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an Si interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, and 140c in the RAN 104 via the Si interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

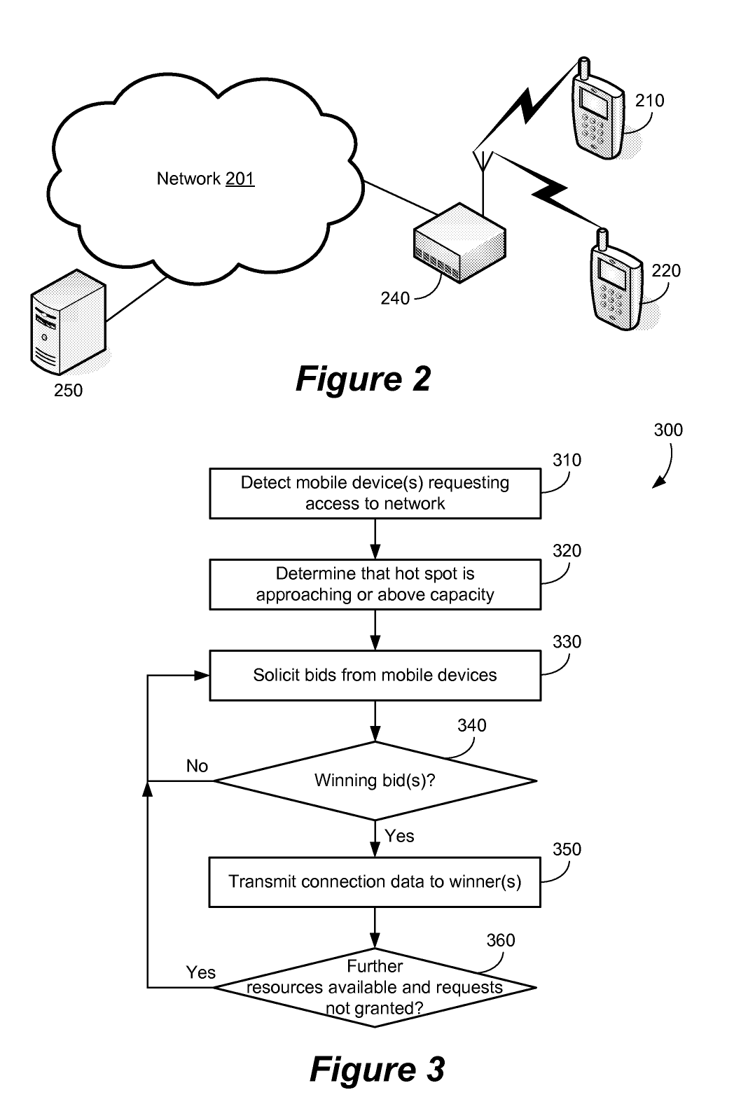

FIG. 2 illustrates hot spot 240 that may be connected to, and provide connectivity to, network 201. Hot spot 240 may be any type of hot spot, including a hot spot providing connectivity to a cellular network, such as an LTE and/or a GSM network, or a hot spot providing connectivity to the Internet, or both. Network 201 may be any type of network, including any type of cellular or wireless network, the Internet, the public switched telephone network (PSTN), any other type of network, and/or any combination thereof. Mobile devices 210 and 220 may be capable of communicating with hot spot 240 using any type of wireless communications means, including Wi-Fi, LTE, and GSM communications means. Mobile device 210 and 220 may be any type of wireless communications devices, including smart phones, cellular telephones, portable computers, tablet computers, laptop computers, notebook computers, etc.

In an embodiment, hot spot 240 may determine whether and how to provide connectivity to network 201 for mobile devices using an auction and bidding method. For example, hot spot 240 may determine which device among mobile devices 210 and 220 is offering the highest bid for access to network 201, and provide access to that device. Alternatively, or in addition, hot spot 240 may also provide access to a lower bidding device, but at a lower bandwidth. Such a system may be especially beneficial where there are more devices attempting to connect to hot spot 240 than hot spot 240 can service.

Method 300 of FIG. 3 is a non-limiting exemplary method of providing access to a network by a hot spot using an auction and bidding methods. Note that any of the functions and/or actions described in regard to any of the blocks of method 300 may be performed in any order, in isolation, with a subset of other functions and/or actions described in regard to any of the other blocks of method 300, and in combination with other functions and/or actions, including those described herein and those not set forth herein. All such embodiments are contemplated as within the scope of the present disclosure.

At block 310, a hot spot may detect and/or receive one or more requests for access to a network to which it provides connectivity for wireless devices. Such a request may be of any type, including Wi-Fi, LTE, and GSM access requests.

At block 320, the hot spot may determine that it is servicing a number of devices such that it is near, at, or above its capacity to service such devices. For example, the hot spot may be able to provide a full amount of a predetermined bandwidth to each of a predetermined number of devices, and may be currently servicing the predetermined number of devices, more than the predetermined number of devices, or just one or a few devices less than the predetermined number of devices. In an embodiment, this determination may be made relative to a predetermined threshold. For example, the hot spot may determine that it is currently servicing a number of devices that is below, approaching, at, or above a threshold number of devices. Alternatively, the hot spot may determine that the bandwidth utilization of the devices currently being serviced is below, approaching, at, or above a threshold amount of bandwidth or a threshold percentage of bandwidth utilization. Upon making such a determination, the hot spot may determine at block 320 that it will use an auction and bidding method to service the devices that have most recently sent requests for access to its network. The hot spot may also determine to engage the devices that it is already servicing in the auction process. Note that the hot spot may determine access to the network using the auction and bidding method even if it is not at, above, or approaching it capacity to service devices. Thus, block 320, like all blocks of any method described herein, is optional.

At block 330, the hot spot may solicit bids from one or more mobile devices. This may be accomplished in a variety of ways. For example, a mobile device that attempts to access a network via a hot spot may interact with the hot spot using a software application that is configured on the mobile device for bidding and auctions. The mobile device may be configured already with such software, or the mobile device may be instructed to download such software, for example from the hot spot, in order to participate in the bidding and auction process. This download may be a pull process, where the hot spot provides a message to a newly detected device, for example via a web page generated by the hot spot, asking the user of the mobile device to activate a link on the message that will cause the auction and bidding software to be downloaded onto the mobile device. Alternatively, the hot spot may attempt to push, or transmit proactively, the software to the mobile device upon detection of the mobile device. In another alternative, no special software may be required on the mobile device, but rather, the hot spot may ask for bids via a web page generated by the hot spot and may collect such bids using web page technologies known to those skilled in the art. Note that the hot spot may indicate to the devices requesting network access any minimum bids, amount of access that is available to a winner of the auction (e.g., bandwidth, length of connection, etc.), number of currently connected devices, auction history including past winners, and any other information that may typically be provided to a bidder and/or that a bidder may find useful. Any variations of these, and any other means or methods of soliciting bids, are contemplated as within the scope of the present disclosure.

At block 340, the hot spot may determine if there are any winning bidders, for example by determining a highest bidder, in one embodiment, who has bid an amount at or over a minimum bid amount. The hot spot may determine more than one winner based on resources available to service devices. For example, the hot spot may have resources available to service three devices, and may therefore determine that the top three devices are winners. If the hot spot has enough resources to service all or more than the number of devices requesting network access via the hot spot, the hot spot may accept all bidding devices as winners. Any method or means of determining winning bidding devices may be used and all such methods and means are contemplated as within the scope of the present disclosure. If there are no winning bidders, for example if no devices have bid above a minimum set by the hot spot, then, returning to block 330, bids may again be solicited from the mobile devices. In such circumstances, the hot spot may make additional adjustments to encourage more bidding, such as lowering a minimum bid or increasing the resources available to the winning bidder(s).

At block 350, any connection data necessary for connecting to the hot spot may be transmitted to the winning device(s). This may include any information needed to connect to any type of wireless hub, router, or any other type of hot spot, such as security credentials, connection type, etc.

At block 360, the hot spot may determine whether there are resources remaining on the hot spot that would allow it to service additional devices, and whether there are remaining devices that are requesting resources. If so, the hot spot may engage in the bidding process again in order to allow the remaining devices the opportunity to access the network via the hot spot. In such embodiments, the hot spot may make adjustments to encourage the remaining devices bid on a connection to the hot spot, such as lowering the bid minimum. Such adjustments may also include reducing the amount of bandwidth available to winners of additional auctions along with lowering the bid minimums. Any other actions may be taken by the hot spot to encourage additional bidding for the remaining resources. If further resources are available, and there are remaining devices requesting access to the network via the hot spot, at block 330 additional bids may be solicited from such devices.

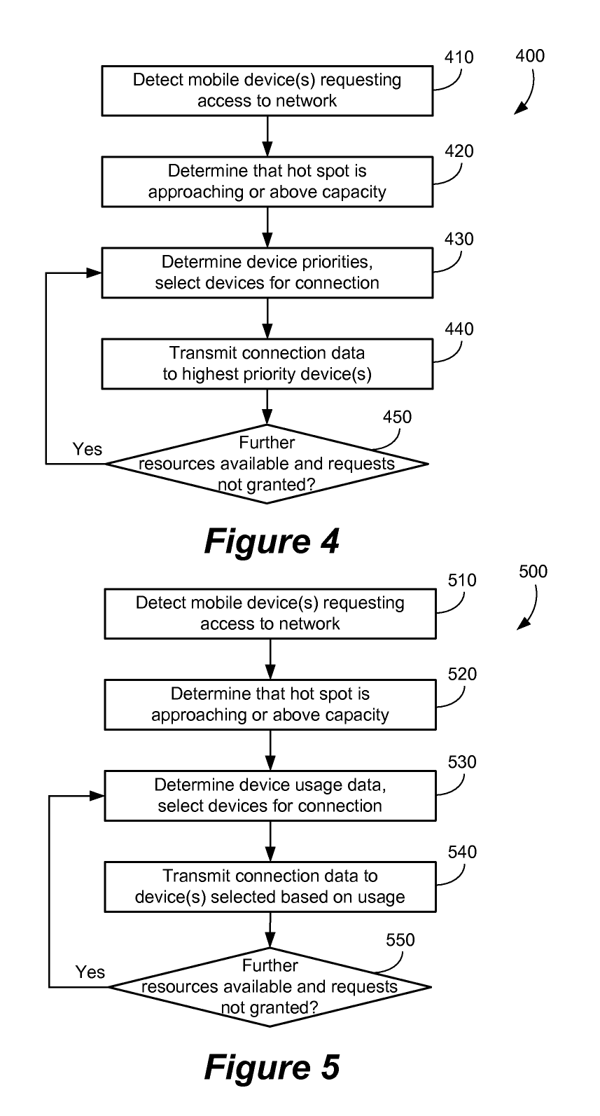

In an embodiment, a hot spot, such as hot spot 240 of FIG. 2, may provide access to a network based on mobile device priority. Method 400 of FIG. 4 is a non-limiting exemplary method of providing access to a network by a hot spot based on mobile device priority. Note that any of the functions and/or actions described in regard to any of the blocks of method 400 may be performed in any order, in isolation, with a subset of other functions and/or actions described in regard to any of the other blocks of method 400, and in combination with other functions and/or actions, including those described herein and those not set forth herein. All such embodiments are contemplated as within the scope of the present disclosure.

At block 410, a hot spot may receive and/or detect requests from one or more mobile device for connectivity to a network via the hot spot.

At block 420, the hot spot may determine that it is servicing a number of devices such that it is near, at, or above its capacity to service such devices. For example, the hot spot may be able to provide a full amount of a predetermined bandwidth to each of a predetermined number of devices, and may be currently servicing the predetermined number of devices, more than the predetermined number of devices, or just one or a few devices less than the predetermined number of devices. In an embodiment, this determination may be made relative to a predetermined threshold. For example, the hot spot may determine that it is currently servicing a number of devices that is below, approaching, at, or above a threshold number of devices. Alternatively, the hot spot may determine that the bandwidth utilization of the devices currently being serviced is below, approaching, at, or above a threshold amount of bandwidth or a threshold percentage of bandwidth utilization. Upon making such a determination, the hot spot may determine at block 420 that it will use the priority of the requesting device to determine how to service the devices that have most recently sent requests for access to the network. The hot spot may also determine to evaluate the priority of the devices that it is already servicing in order to ensure that the highest priority devices get access to the network via the hot spot. Note that the hot spot may determine access to the network using mobile device priorities even if it is not at, above, or approaching it capacity to service devices. Thus, block 420, like all blocks of any method described herein, is optional.

At block 430, the hot spot may determine the priorities associated with each requesting device. This may be accomplished via any means. For example, the hot spot may query each requesting mobile device for priority information and may receive such information from each device. In such an embodiment, each device may be configured with such information in advance using any means. Alternatively, referring again to FIG. 2, server 250 may contain a database including priorities for mobile devices. In such an embodiment, the hot spot may query each requesting mobile device for identification data and may receive and send such data to server 250 that may return priority information to the hot spot. In such an embodiment, where the priority server has no priority information for a mobile device, the hot spot may assign such a mobile device a default priority, for example, the lowest priority. In another embodiment, the hot spot may maintain its own database of priorities and may determine device priority based on data received from such devices.

In yet another embodiment, the hot spot may generate a priority for each requesting device based on some criteria. For example, the hot spot may determine, using any means or method, that the network with which it is connected is a home network for some devices, and may therefore assign a higher (or lower) priority to such devices than the priority it assigns to devices for which the network is not a home network. Alternatively, the hot spot may determine a signal strength for each device and assign a higher (or lower) priority to devices with a higher (or lower) signal strength. In another alternative, the hot spot may assign priorities based on the type of device that is requesting access. For example, mobile telephones may be given higher priority since mobile telephones may use fewer resources than lap tops and smart phones. The opposite rationale may also be used in an embodiment. For example, because such devices use more resources, smart phones and laptops may be given higher priority than mobile telephones. Any other type of priority scheme may be used, and any other means and methods of determining priority for mobile devices requesting access to a network via a hot spot may be used. All such embodiments are contemplated as within the scope of the present disclosure.

At block 440 any connection data necessary for connecting to the hot spot may be transmitted to the highest priority device(s). This may include any information needed to connect to any type of wireless hub, router, or any other type of hot spot, such as security credentials, connection type, etc. The hot spot may transmit such data to all the higher priority devices that it is able to service, only the highest priority devices, all devices requesting connection where the hot spot has resources to service all devices, or any other set or subset of devices requesting access to a network via the hot spot.

At block 450, the hot spot may determine whether there are resources remaining on the hot spot that would allow it to service additional devices, and whether there are remaining devices that are requesting resources. If so, the hot spot may evaluate the remaining devices' priorities at block 430 and provide them access according to priority as was done for the higher priority devices. Any other actions may be taken by the hot spot to service the remaining devices based on priority.

In an embodiment, a hot spot, such as hot spot 240 of FIG. 2, may provide access to a network based on the usage of the requesting mobile devices. Method 500 of FIG. 5 is a non-limiting exemplary method of providing access to a network by a hot spot based on mobile device usage. Note that any of the functions and/or actions described in regard to any of the blocks of method 500 may be performed in any order, in isolation, with a subset of other functions and/or actions described in regard to any of the other blocks of method 500, and in combination with other functions and/or actions, including those described herein and those not set forth herein. All such embodiments are contemplated as within the scope of the present disclosure.

At block 510, a hot spot may receive and/or detect requests from one or more mobile device for connectivity to a network via the hot spot.

At block 520, the hot spot may determine that it is servicing a number of devices such that it is near, at, or above its capacity to service such devices. For example, the hot spot may be able to provide a full amount of a predetermined bandwidth to each of a predetermined number of devices, and may be currently servicing the predetermined number of devices, more than the predetermined number of devices, or just one or a few devices less than the predetermined number of devices. In an embodiment, this determination may be made relative to a predetermined threshold. For example, the hot spot may determine that it is currently servicing a number of devices that is below, approaching, at, or above a threshold number of devices. Alternatively, the hot spot may determine that the bandwidth utilization of the devices currently being serviced is below, approaching, at, or above a threshold amount of bandwidth or a threshold percentage of bandwidth utilization. Upon making such a determination, the hot spot may determine at block 520 that it will use usage data of the requesting devices to determine how to service the devices that have most recently sent requests for access to the network. The hot spot may also determine to evaluate the usage data of the devices that it is already servicing in order to ensure that access to the network via the hot spot is based on usage. Note that the hot spot may determine access to the network using mobile device usage data even if it is not at, above, or approaching it capacity to service devices. Thus, block 520, like all blocks of any method described herein, is optional.

At block 530, the hot spot may determine device usage data. Such data may be historical usage data that may include length of time of past connection(s) to the hot spot, number of past connection(s) to the hot spot, bandwidth used during one or more past connections, bandwidth used during the current connection to the hot spot, etc. Such data that includes bandwidth data may include amounts of bandwidth used and/or percentages of allotted bandwidth used. Determining device usage data may be accomplished using any effective means. In an embodiment, the hot spot may maintain device usage data in a local database or a database that is otherwise accessible by the hot spot. Alternatively, the hot spot may retrieve device usage data from a remote device that may be configured to capture such data, such as server 250 of FIG. 2. In an embodiment, the hot spot may obtain such data using identification information received from the mobile devices requesting access to a network via the hot spot. Any other means of obtaining or determining device usage data may be used.

The hot spot may select devices for connection at block 530 using any means. In an embodiment, the hot spot may rank devices by usage data, and transmit connection data to the devices ranked highest. For example, devices with the heaviest historical usage (by any metric, including bandwidth used, percentage of available bandwidth used, length of time of past connection(s), number of past connections to hot spot, etc.) may be ranked higher than those with lighter or no historical usage. This may facilitate providing to heavier users the resources that they require. Alternatively, devices with no usage history or very light usage history (again, by any metric, including bandwidth used, percentage of available bandwidth used, length of time of past connection(s), number of past connections to hot spot, etc.) may be ranked higher than heavier users. This type of ranking may facilitate providing resources to all users rather than allowing heavier users to dominate access to the hot spot.

In an embodiment, the amount of time since the device has last connected to the hot spot may be used. Thus, the hot spot may determine the most recent usage as the time of the most recent connection to the hot spot for each device, and rank the devices accordingly. For example, devices that have more recently been connected to the hot spot may be ranked higher, with the most recently connected device ranked highest, and devices less recently connected may be ranked lower, with those devices having the longest amount of time since the last connection or devices that have never connected to the hot spot being ranked the lowest. This may facilitate providing resources to the most recent users. Alternatively, the ranking may be reversed, where the devices that have never connected to the hot spot or that have connected a relatively long time ago may be ranked higher than those devices that have connected more recently. This may facilitate distributing resources such that all devices get a relatively equal opportunity to connect to the hot spot. Any other means and methods of ranking devices based on usage may be used and all such means any methods are contemplated as within the scope of the present disclosure.

At block 540 any connection data necessary for connecting to the hot spot may be transmitted to the highest ranked device(s). This may include any information needed to connect to any type of wireless hub, router, or any other type of hot spot, such as security credentials, connection type, etc. The hot spot may transmit such data to all the higher ranked devices that it is able to service, only the highest ranked devices, all devices requesting connection where the hot spot has resources to service all devices, or any other set or subset of devices requesting access to a network via the hot spot.

At block 550, the hot spot may determine whether there are resources remaining on the hot spot that would allow it to service additional devices, and whether there are remaining devices that are requesting resources. If so, the hot spot may evaluate the remaining devices' usage data and/or rankings based on usage data at block 530 and provide them access according to usage as was done for the other devices. Any other actions may be taken by the hot spot to service the remaining devices based on usage.

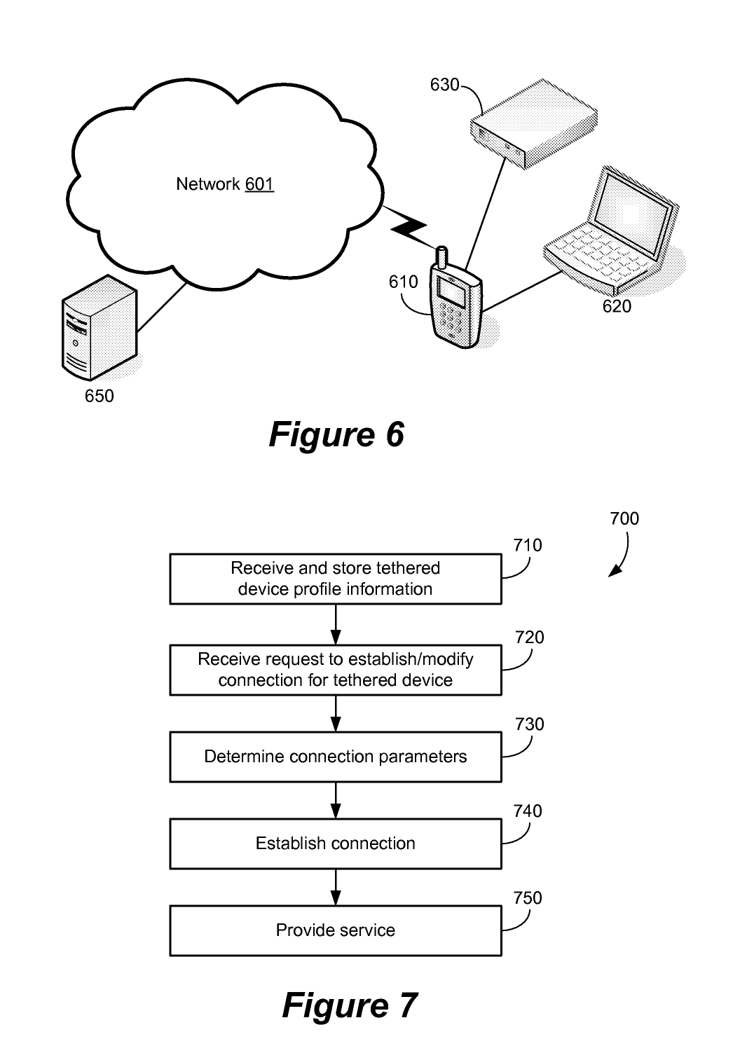

In an embodiment, a user's mobile device may function as a hot spot for devices that may connect to the mobile device for access to a network, such as an LTE network. FIG. 6 illustrates a non-limiting exemplary network configuration and user devices. Network 601 may be any type of network, including any type of cellular or wireless network, the Internet, the PSTN, any other type of network, and/or any combination thereof. Mobile device 610 may be capable of communicating with network 601 using any type of wireless communications means, including Wi-Fi, LTE, and GSM communications means. Mobile device 610 may be any type of wireless communications device, including a smart phone, a cellular telephone, a portable computer, a tablet computer, a laptop computer, a notebook computer, a medical device, any device in a home that may connect to a mobile device, etc. In an embodiment, network 601 is an LTE network, and mobile device 610 is a mobile device configured to operate with an LTE network.

Mobile device 610 may be configured to communicate with other user devices, such as laptop 620 and set top box 630. Laptop 620 and set top box 630 are merely exemplary devices, and any other type of device capable of communicating with any type of wireless communications device using any means is contemplated as within the scope of the present disclosure. Either or both of laptop 620 and set top box 630 may communicate with mobile device 610 wirelessly, for example using a short range wireless protocol such as BLUETOOTH®, and either or both of laptop 620 and set top box 630 may communicate with mobile device 610 using wired means, such as a USB cable. Laptop 620 and set top box 630 may be communicatively connected to mobile device 610 for purposes of communicating with network 601, which may be generally referred to as “tethering.” In an embodiment, these devices may use mobile device 610 as a gateway to network 601, and mobile device 610 may provide the primary means of connectivity for laptop 620 and set top box 630 to network 601.

Server 650 may be configured to store profile information for tethered devices such as laptop 620 and set top box 630. In an embodiment, server 650 may be a home subscriber server (HSS) or a home location register (HLR) in a cellular communications network such as an LTE network. The profile may be configured, at least in part, by a user of mobile device 610. Such a profile may include descriptions of potentially tethered devices, usage information for such devices such as bandwidth required or requested, quality of service (QoS) desired, etc. In such an embodiment, upon tethering of either laptop 620 or set top box 630, or upon otherwise determining that tethered access to network 601 is desired for the tethered device, mobile device 610 may transmit data to network 601 relating to or identifying the tethered device. Such a transmission may include any data that may be used by network 601 to retrieve profile information for the tethered device from server 650. Any type of transmission including any data may be used, and will generally be referred to herein as a tethering request.

Upon receiving the tethering request, network 601 may query server 650 or otherwise retrieve profile data for the device(s) associated with the tethering request. This data may then be used by network 601 and/or mobile device 610 to set up a connection between mobile device 610 and network 601 that is specifically configured for providing connectivity of the tethered device to network 601 via mobile device 610. Alternatively, this data may be used by network 601 and/or mobile device 610 to modify a currently established connection between mobile device 610 and network 601 so that the currently established connection is specifically configured for providing connectivity of the tethered device to network 601 via mobile device 610.

In an embodiment, rather than being configured in advance of tethering, network 601 may determine configuration parameters for a connection with mobile device 610 to be used with a tethered device based on the type of device that is tethered at the time the tethered device is to begin using the connection. For example, server 650 may be configured with a database including identifiers of specific devices and/or types of devices, and associated connection parameters to be used with connections to mobile devices to which such specific devices and/or types of devices may be tethered. Upon initiating a tethering connection, mobile device 610 may transmit to network 601 device-specific data and/or device type data associated with the tethered device. Network 601 may then query or otherwise obtain from server 650 connection parameters that may be used by network 601 and/or mobile device 610 to set up a connection, or modify an established connection, between mobile device 610 and network 601 that is specifically configured for providing connectivity of the tethered device to network 601 via mobile device 610. For example, upon receiving data indicating that set top box 630 is a set top box, network 601 may retrieve set top box-associated connection parameters and establish or modify a connection with mobile device 610 that is configured to provide service for a tethered set top box. Alternatively, network 601 may retrieve parameters associated with a specific model of device, manufacture of device, class of device, etc. All such embodiments are contemplated as within the scope of the present disclosure.

Where multiple devices are requesting access to network 601 via tethering to mobile device 610, mobile device 610 may provide access using any methods described herein in regard to the hot spot of FIG. 2. For example, methods 300, 400, and 500 of FIGS. 3, 4, and 5, respectively, may each be used by mobile device 610 to determine whether and how to provide access to network 601 via tethering. Rather than such determinations being made by mobile device 610, such determinations may alternatively be made by network 601, in one embodiment in conjunction with any data that may be on server 650. Such data may include profiles established by a user and associated with the tethered device specifically, profiles associated with the device type or device model, etc., usage data for the tethered device, and/or any other data described herein or that may be on a server.

In providing connectivity to tethered devices, the operator of network 601 may offer different rate plans that are specifically designed for the type of use and/or type of user that will be using the plan. For example, an operator may offer a plan for consumers generally, a plan for consumers that tether automotive systems to their mobile devices (e.g., devices in a controller area network (CAN)), a plan for medical device use or home wireless device use (e.g., ZIGBEE®), etc. Such plans may be tailored to the needs of the types of devices that may be tethered to a user's mobile device, and may generate specific configurations and profiles that may be used when the user tethers devices associated with the plan to his or her mobile device. Such plans may be priced according to the types of devices in the plan, and the user may be billed a flat rate or based on any usage metric, including duration of connection, bandwidth consumed, etc.

Method 700 of FIG. 7 is a non-limiting exemplary method of providing access to a network for a tethered device via a mobile device. Note that any of the functions and/or actions described in regard to any of the blocks of method 700 may be performed in any order, in isolation, with a subset of other functions and/or actions described in regard to any of the other blocks of method 700, and in combination with other functions and/or actions, including those described herein and those not set forth herein. The functions and/or actions described in regard to any of the blocks of method 700 may be performed by any device within a network, any device in communication with a network, and combination of multiple such devices. All such embodiments are contemplated as within the scope of the present disclosure.

At block 710, tethered device profile information may be received and stored. Such information may be received when a user establishes up an account with an operator of a network, or when a user otherwise provides such information to the operator. The information may be stored on a server, such as server 650, or any other server, HLR, HSS, or another network device or device accessible to a network. Alternatively, block 710 may not be performed and instead a network may receive a device type in a request for service as described below.

At block 720, the network may receive a request to establish or modify a connection that is to be used for providing connectivity to a tethered device. This request may be in any form, including a service request explicitly indicating that a tethered device is to be using the connection or a notification that a tethered device is now connected to the mobile device transmitting the notification. The request may include information identifying the device tethered, the type of device tethered, the model and/or manufacture of the tethered device, etc.

At block 730, the network may determine the parameters to be used to establish and/or modify a connection in order to service a tethered device via a mobile device. The parameters may be determined by querying or otherwise obtaining such parameters from a server (e.g., server 650 of FIG. 6, an HLR, and an HSS) by providing information regarding the tethered device to the server. This information may be derived from the request received at block 720. For example, the information received in the request may include a user identifier and/or device identifier that may be used by a server to perform a database lookup to determine specific configurations for that particular user and/or device. Alternatively, the request may include a device type and/or a specific device identifier (e.g., model, manufacture, etc.) that may be used by a server to perform a database lookup to determine specific configurations for that particular device type, model, etc. Alternatively, the request may include specific configuration requests, such as bandwidth, duration, etc.

At block 740, using the parameters determined at block 730, the network may establish a connection with a mobile device in order to provide service to a tethered device at block 750. In establishing the connection to the mobile device, the network may transmit some or all of the parameters determined at block 730 to the mobile device.

The methods and systems described above assist in providing intelligent hot spot and tethering capabilities. By implementing the present disclosure, the user experience may be improved. Set forth below are further exemplary systems, devices, and components in which aspects of intelligent hot spot and tethering may be implemented.

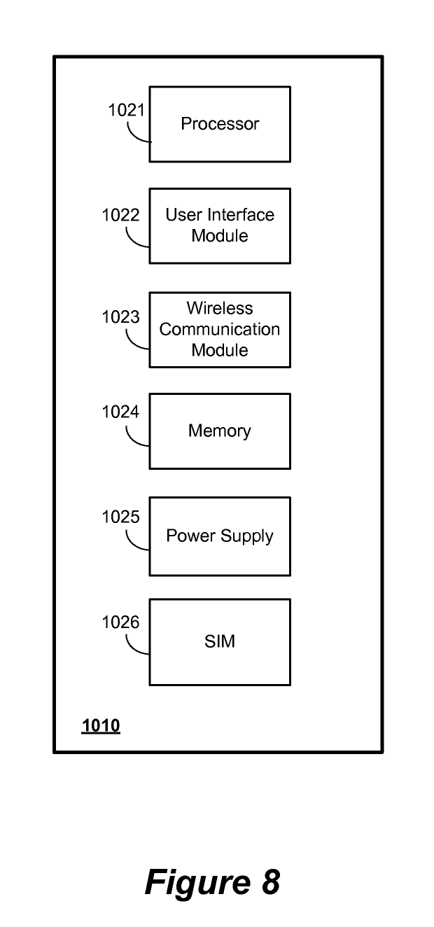

FIG. 8 illustrates an example wireless device 1010 that may be used in connection with an embodiment. References will also be made to other figures of the present disclosure as appropriate. For example, mobile devices 210, 220, and/or 610 may be wireless devices of the type described in regard to FIG. 8, and may have some, all, or none of the components and modules described in regard to FIG. 8. It will be appreciated that the components and modules of wireless device 1010 illustrated in FIG. 8 are illustrative, and that any number and type of components and/or modules may be present in wireless device 1010. In addition, the functions performed by any or all of the components and modules illustrated in FIG. 8 may be performed by any number of physical components. Thus, it is possible that in some embodiments the functionality of more than one component and/or module illustrated in FIG. 8 may be performed by any number or types of hardware and/or software.

Processor 1021 may be any type of circuitry that performs operations on behalf of wireless device 1010. Such circuitry may include circuitry and other components that enable processor 1021 to perform any of the functions and methods described herein. Such circuitry and other components may also enable processor 1021 to communicate and/or interact with other devices and components, for example any other component of device of wireless device 1010, in such a manner as to enable processor 1021 and such other devices and/or components to perform any of the disclosed functions and methods. In one embodiment, processor 1021 executes software (i.e., computer readable instructions stored in a computer readable medium) that may include functionality related to providing an intelligent hot spot and intelligent tethering, for example. User interface module 1022 may be any type or combination of hardware and/or software that enables a user to operate and interact with wireless device 1010, and, in one embodiment, to interact with a system or software enabling the user to place, request, and/or receive calls, text communications of any type, voicemail, voicemail notifications, voicemail content and/or data, and/or a system or software enabling the user to view, modify, or delete related software objects. For example, user interface module 1022 may include a display, physical and/or “soft” keys, voice recognition software, a microphone, a speaker and the like. Wireless communication module 1023 may be any type of transceiver including any combination of hardware and/or software that enables wireless device 1010 to communicate with wireless network equipment. Memory 1024 enables wireless device 1010 to store information, such as APNs, MNCs, MCCs, text communications content and associated data, multimedia content, software to efficiently process radio resource requests and service requests, and radio resource request processing preferences and configurations. Memory 1024 may take any form, such as internal random access memory (RAM), an SD card, a microSD card and the like. Power supply 1025 may be a battery or other type of power input (e.g., a charging cable that is connected to an electrical outlet, etc.) that is capable of powering wireless device 1010. SIM 1026 may be any type of Subscriber Identity Module and may be configured on a removable or non-removable SIM card that allows wireless device 1010 to store data on SIM 1026.

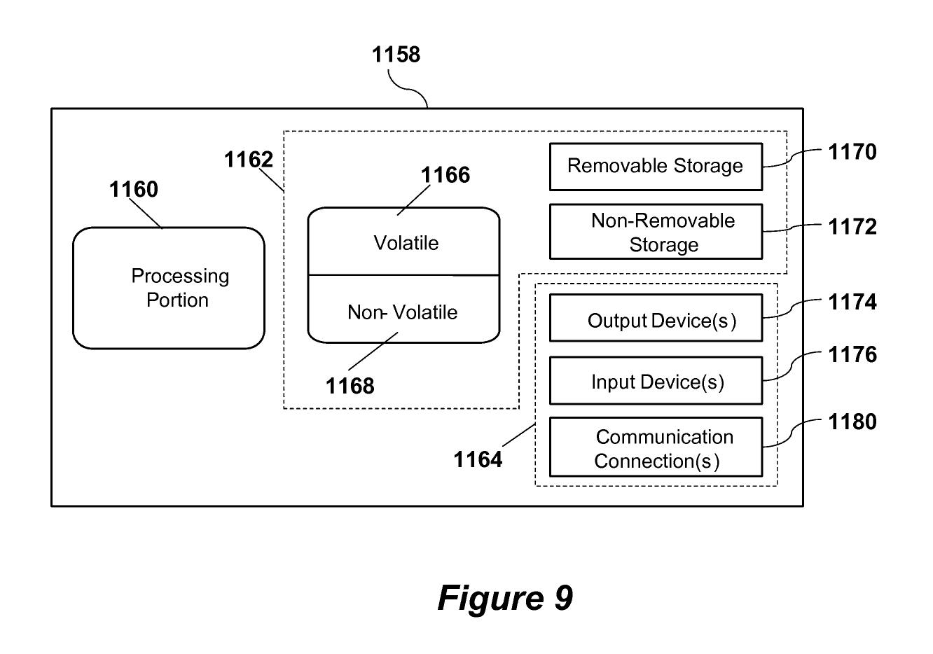

FIG. 9 is a block diagram of an example processor 1158 which may be employed in any of the embodiments described herein, including as one or more components of mobile devices 210, 220, and 610, network equipment such as servers 250 and 650, other devices such as hot spot 240, laptop 620, and set top box 630, any other component of networks 201 and 601, and/or any related equipment, and/or as one or more components of any third party system or subsystem that may implement any portion of the subject matter described herein. It is emphasized that the block diagram depicted in FIG. 9 is exemplary and not intended to imply a specific implementation. Thus, the processor 1158 can be implemented in a single processor or multiple processors. Multiple processors can be distributed or centrally located. Multiple processors can communicate wirelessly, via hard wire, or a combination thereof. Processor 1158 may include circuitry and other components that enable processor 1158 to perform any of the functions and methods described herein. Such circuitry and other components may also enable processor 1158 to communicate and/or interact with other devices and components, for example any other component of any device disclosed herein or any other device, in such a manner as to enable processor 1158 and such other devices and/or components to perform any of the disclosed functions and methods.

As depicted in FIG. 9, the processor 1158 comprises a processing portion 1160, a memory portion 1162, and an input/output portion 1164. The processing portion 1160, memory portion 1162, and input/output portion 1164 are coupled together (coupling not shown in FIG. 9) to allow communications between these portions. The input/output portion 1164 is capable of providing and/or receiving components, commands, and/or instructions, utilized to, for example, request and receive hot spot access, tethering-specific network connections, communications requests from tethered devices, establish and terminate communications sessions, transmit and receive service requests and data access request data and responses, transmit, receive, store and process text, data, and voice communications, execute software that efficiently processes radio resource requests, receive and store service requests and radio resource requests, radio resource request processing preferences and configurations, and/or perform any other function described herein.

The processor 1158 may be implemented as a client processor and/or a server processor. In a basic configuration, the processor 1158 may include at least one processing portion 1160 and memory portion 1162. The memory portion 1162 can store any information utilized in conjunction with establishing, transmitting, receiving, and/or processing text, data, and/or voice communications, communications-related data and/or content, voice calls, other telephonic communications, etc. For example, the memory portion is capable of storing tethered device profiles, usage data, service requests, radio resource requests, QoS, APN, and other connection parameters, software for a providing an intelligent hot spot and intelligent tethering, text and data communications, calls, voicemail, multimedia content, visual voicemail applications, etc. Depending upon the exact configuration and type of processor, the memory portion 1162 can be volatile (such as RAM) 1166, non-volatile (such as ROM, flash memory, etc.) 1168, or a combination thereof. The processor 1158 can have additional features/functionality. For example, the processor 1158 may include additional storage (removable storage 1170 and/or non-removable storage 1172) including, but not limited to, magnetic or optical disks, tape, flash, smart cards or a combination thereof. Computer storage media, such as memory and storage elements 1162, 1170, 1172, 1166, and 1168, may include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium that can be used to store the desired information and that can be accessed by the processor 1158. Any such computer storage media may be part of the processor 1158.

The processor 1158 may also contain the communications connection(s) 1180 that allow the processor 1158 to communicate with other devices, for example through a radio access network (RAN). Communications connection(s) 1180 is an example of communication media. Communication media typically embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection as might be used with a land line telephone, and wireless media such as acoustic, RF, infrared, cellular, and other wireless media. The term computer-readable media as used herein includes both storage media and communication media. The processor 1158 also can have input device(s) 1176 such as keyboard, keypad, mouse, pen, voice input device, touch input device, etc. Output device(s) 1174 such as a display, speakers, printer, etc. also may be included.

A RAN as described herein may comprise any telephony radio network, or any other type of communications network, wireline or wireless, or any combination thereof. The following description sets forth some exemplary telephony radio networks, such as the global system for mobile communications (GSM), and non-limiting operating environments. The below-described operating environments should be considered non-exhaustive. The below-described network architectures merely show how providing an intelligent hot spot and intelligent tethering may be implemented with stationary and non-stationary network structures and architectures. It can be appreciated, however, that providing an intelligent hot spot and intelligent tethering as described herein may be incorporated with existing and/or future alternative architectures for communication networks as well.

The GSM is one of the most widely utilized wireless access systems in today's fast growing communication environment. The GSM provides circuit-switched data services to subscribers, such as mobile telephone or computer users. The General Packet Radio Service (GPRS), which is an extension to GSM technology, introduces packet switching to GSM networks. The GPRS uses a packet-based wireless communication technology to transfer high and low speed data and signaling in an efficient manner. The GPRS attempts to optimize the use of network and radio resources, thus enabling the cost effective and efficient use of GSM network resources for packet mode applications.

The exemplary GSM/GPRS environment and services described herein also may be extended to 3G services, such as Universal Mobile Telephone System (UMTS), Frequency Division Duplexing (FDD) and Time Division Duplexing (TDD), High Speed Packet Data Access (HSPDA), cdma2000 1x Evolution Data Optimized (EVDO), Code Division Multiple Access-2000 (cdma2000 3x), Time Division Synchronous Code Division Multiple Access (TD-SCDMA), Wideband Code Division Multiple Access (WCDMA), Enhanced Data GSM Environment (EDGE), International Mobile Telecommunications-2000 (IMT-2000), Digital Enhanced Cordless Telecommunications (DECT), 4G Services such as Long Term Evolution (LTE), etc., as well as to other network services that become available in time. In this regard, intelligent hot spots and intelligent tethering may be applied independently of the method of data transport and do not depend on any particular network architecture or underlying protocols.

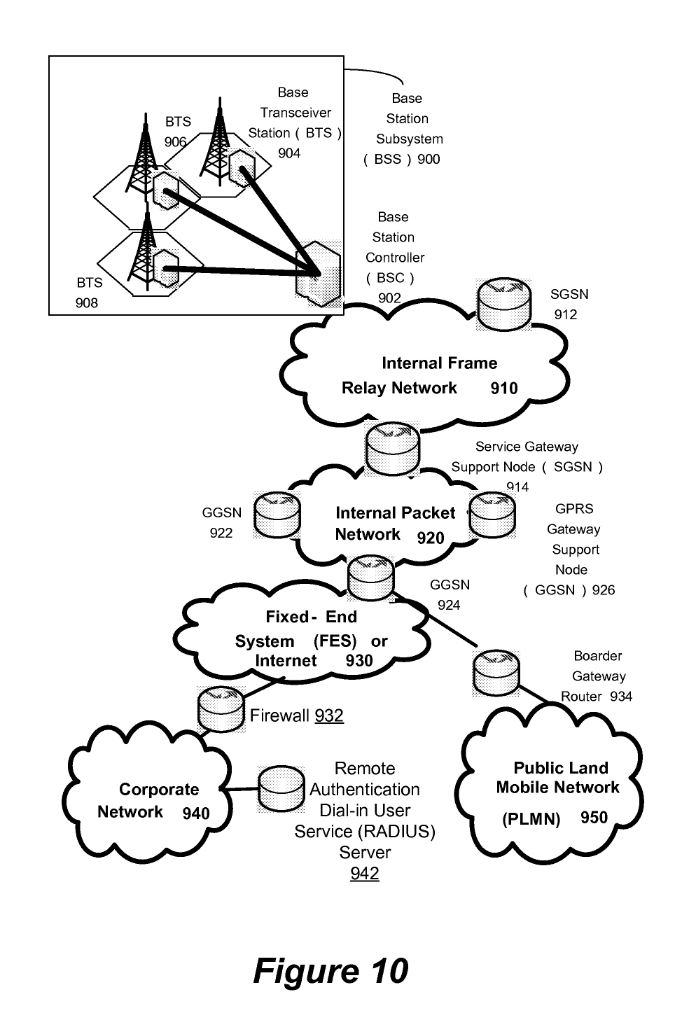

FIG. 10 depicts an overall block diagram of an exemplary packet-based mobile cellular network environment, such as a GPRS network, in which intelligent hot spots and intelligent tethering systems and methods such as those described herein may be practiced. In an example configuration, any RAN as described herein may be encompassed by or interact with the network environment depicted in FIG. 10. Similarly, mobile devices 210, 220, and/or 610 may communicate or interact with a network environment such as that depicted in FIG. 10. In such an environment, there may be a plurality of Base Station Subsystems (BSS) 900 (only one is shown), each of which comprises a Base Station Controller (BSC) 902 serving a plurality of Base Transceiver Stations (BTS) such as BTSs 904, 906, and 908. BTSs 904, 906, 908, etc. are the access points where users of packet-based mobile devices (e.g., mobile devices 210, 220, and 610) become connected to the wireless network. In exemplary fashion, the packet traffic originating from user devices (e.g., mobile devices 210, 220, and 610) may be transported via an over-the-air interface to a BTS 908, and from the BTS 908 to the BSC 902. Base station subsystems, such as BSS 900, may be a part of internal frame relay network 910 that can include Service GPRS Support Nodes (SGSN) such as SGSN 912 and 914. Each SGSN may be connected to an internal packet network 920 through which a SGSN 912, 914, etc. may route data packets to and from a plurality of gateway GPRS support nodes (GGSN) 922, 924, 926, etc. As illustrated, SGSN 914 and GGSNs 922, 924, and 926 may be part of internal packet network 920. Gateway GPRS serving nodes 922, 924 and 926 may provide an interface to external Internet Protocol (IP) networks, such as Public Land Mobile Network (PLMN) 950, corporate intranets 940, or Fixed-End System (FES) or the public Internet 930. As illustrated, subscriber corporate network 940 may be connected to GGSN 924 via firewall 932, and PLMN 950 may be connected to GGSN 924 via border gateway router 934. The Remote Authentication Dial-In User Service (RADIUS) server 942 may be used for caller authentication when a user of a mobile cellular device calls corporate network 940.

Generally, there can be four different cell sizes in a GSM network, referred to as macro, micro, pico, and umbrella cells. The coverage area of each cell is different in different environments. Macro cells may be regarded as cells in which the base station antenna is installed in a mast or a building above average roof top level. Micro cells are cells whose antenna height is under average roof top level. Micro-cells may be typically used in urban areas. Pico cells are small cells having a diameter of a few dozen meters. Pico cells may be used mainly indoors. On the other hand, umbrella cells may be used to cover shadowed regions of smaller cells and fill in gaps in coverage between those cells.

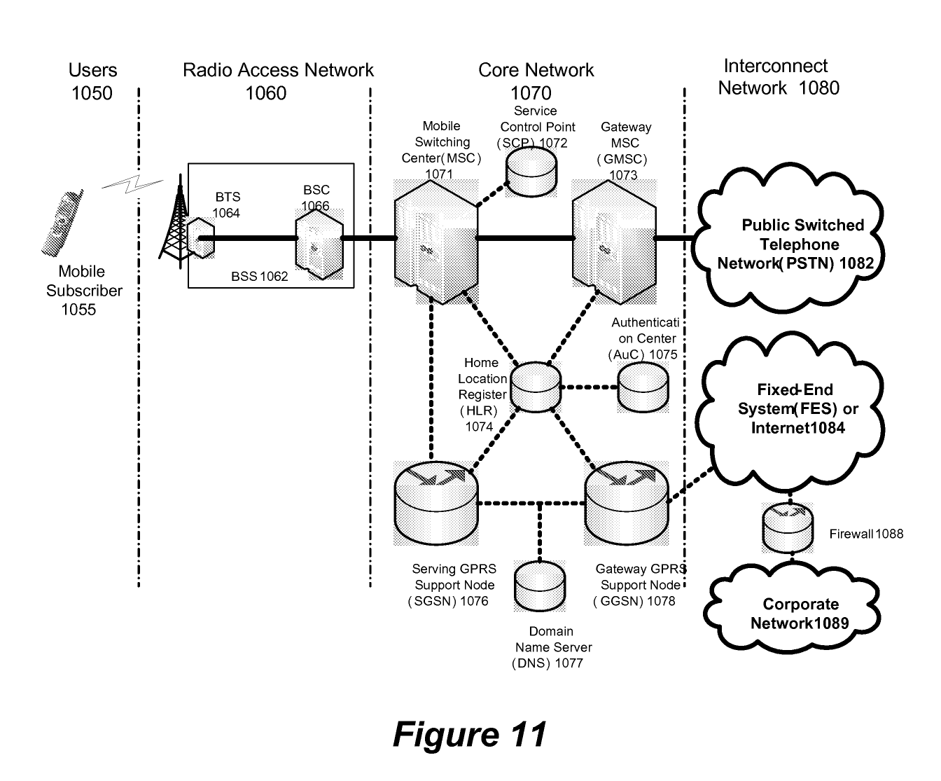

FIG. 11 illustrates an architecture of a typical GPRS network segmented into four groups: users 1050, radio access network 1060, core network 1070, and interconnect network 1080. Users 1050 may comprise a plurality of end users (though only mobile subscriber 1055 is shown in FIG. 11). In an example embodiment, the device depicted as mobile subscriber 1055 may comprise any of mobile devices 210, 220, and 610. Radio access network 1060 comprises a plurality of base station subsystems such as BSSs 1062, which include BTSs 1064 and BSCs 1066. Core network 1070 comprises a host of various network elements. As illustrated here, core network 1070 may comprise Mobile Switching Center (MSC) 1071, Service Control Point (SCP) 1072, gateway MSC 1073, SGSN 1076, Home Location Register (HLR) 1074, Authentication Center (AuC) 1075, Domain Name Server (DNS) 1077, and GGSN 1078. Interconnect network 1080 may also comprise a host of various networks and other network elements. As illustrated in FIG. 11, interconnect network 1080 may comprise Public Switched Telephone Network (PSTN) 1082, Fixed-End System (FES) or Internet 1084, firewall 1088, and Corporate Network 1089.

A mobile switching center may be connected to a large number of base station controllers. At MSC 1071, for instance, depending on the type of traffic, the traffic may be separated in that voice may be sent to Public Switched Telephone Network (PSTN) 1082 through Gateway MSC (GMSC) 1073, and/or data may be sent to SGSN 1076 that may send the data traffic to GGSN 1078 for further forwarding.

When MSC 1071 receives call traffic, for example, from BSC 1066, it may send a query to a database hosted by SCP 1072. The SCP 1072 may process the request and may issue a response to MSC 1071 so that it may continue call processing as appropriate.

The HLR 1074 may be a centralized database for users to register to the GPRS network. In some embodiments, HLR 1074 may be a device such as servers 250 and 650. HLR 1074 may store static information about the subscribers such as the International Mobile Subscriber Identity (IMSI), tethered device profiles as described herein, usage data, subscribed services, and a key for authenticating the subscriber. HLR 1074 may also serve to intercept and determine the validity of destination numbers in messages sent from a device, such as mobile subscriber 1055, as described herein. Associated with HLR 1074 may be AuC 1075. AuC 1075 may be a database that contains the algorithms for authenticating subscribers and may include the associated keys for encryption to safeguard the user input for authentication.

In the following, depending on context, the term “mobile subscriber” sometimes refers to the end user and sometimes to the actual portable device, such as mobile devices 210, 220, and 610, used by an end user of a mobile cellular service or a wireless provider. When a mobile subscriber turns on his or her mobile device, the mobile device may go through an attach process by which the mobile device attaches to an SGSN of the GPRS network. In FIG. 11, when mobile subscriber 1055 initiates the attach process by turning on the network capabilities of the mobile device, an attach request may be sent by mobile subscriber 1055 to SGSN 1076. The SGSN 1076 queries another SGSN, to which mobile subscriber 1055 was attached before, for the identity of mobile subscriber 1055. Upon receiving the identity of mobile subscriber 1055 from the other SGSN, SGSN 1076 may request more information from mobile subscriber 1055. This information may be used to authenticate mobile subscriber 1055 to SGSN 1076 by HLR 1074. Once verified, SGSN 1076 sends a location update to HLR 1074 indicating the change of location to a new SGSN, in this case SGSN 1076. HLR 1074 may notify the old SGSN, to which mobile subscriber 1055 was attached before, to cancel the location process for mobile subscriber 1055. HLR 1074 may then notify SGSN 1076 that the location update has been performed. At this time, SGSN 1076 sends an Attach Accept message to mobile subscriber 1055, which in turn sends an Attach Complete message to SGSN 1076.

After attaching itself to the network, mobile subscriber 1055 may then go through the authentication process. In the authentication process, SGSN 1076 may send the authentication information to HLR 1074, which may send information back to SGSN 1076 based on the user profile that was part of the user's initial setup. The SGSN 1076 may then send a request for authentication and ciphering to mobile subscriber 1055. The mobile subscriber 1055 may use an algorithm to send the user identification (ID) and password to SGSN 1076. The SGSN 1076 may use the same algorithm and compares the result. If a match occurs, SGSN 1076 authenticates mobile subscriber 1055.

Next, the mobile subscriber 1055 may establish a user session with the destination network, corporate network 1089, by going through a Packet Data Protocol (PDP) activation process. Briefly, in the process, mobile subscriber 1055 may request access to an Access Point Name (APN), for example, UPS.com, and SGSN 1076 may receive the activation request from mobile subscriber 1055. SGSN 1076 may then initiate a Domain Name Service (DNS) query to learn which GGSN node has access to the UPS.com APN. The DNS query may be sent to the DNS server within the core network 1070, such as DNS 1077, that may be provisioned to map to one or more GGSN nodes in the core network 1070. Based on the APN, the mapped GGSN 1078 may access the requested corporate network 1089. The SGSN 1076 may then send to GGSN 1078 a Create Packet Data Protocol (PDP) Context Request message that contains necessary information. The GGSN 1078 may send a Create PDP Context Response message to SGSN 1076, which may then send an Activate PDP Context Accept message to mobile subscriber 1055.

Once activated, data packets of the call made by mobile subscriber 1055 may then go through radio access network 1060, core network 1070, and interconnect network 1080, in a particular fixed-end system, or Internet 1084 and firewall 1088, to reach corporate network 1089.

Thus, network elements that can invoke the functionality of intelligent hot spots and intelligent tethering systems and methods such as those described herein may include, but are not limited to, Gateway GPRS Support Node tables, Fixed End System router tables, firewall systems, VPN tunnels, and any number of other network elements as required by the particular digital network.

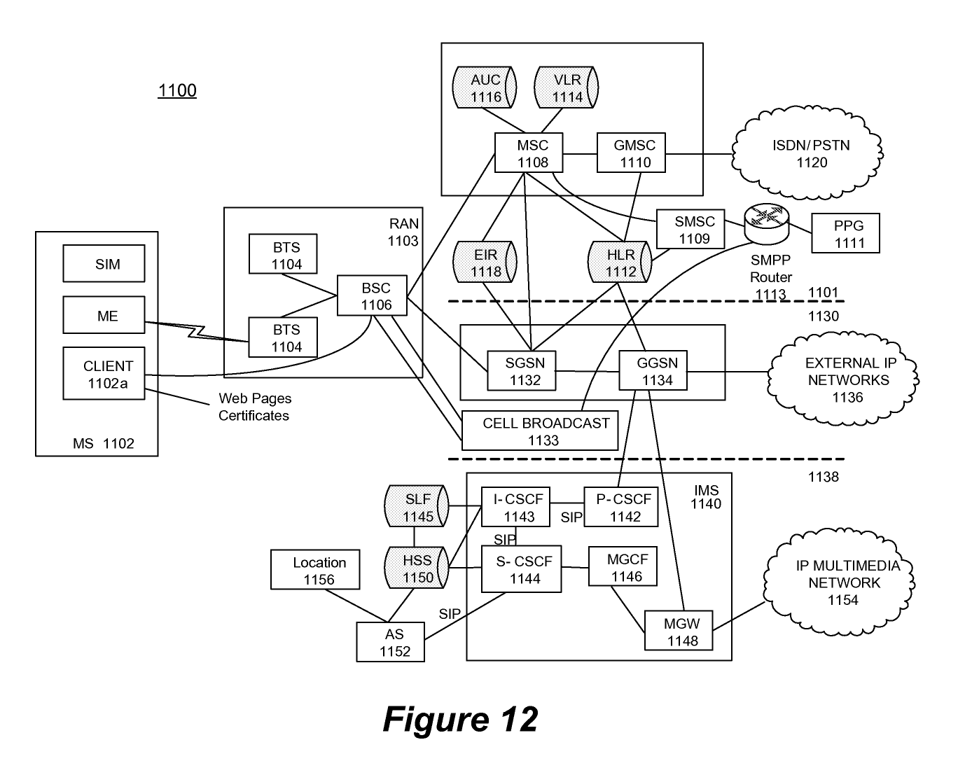

FIG. 12 illustrates another exemplary block diagram view of a GSM/GPRS/IP multimedia network architecture 1100 in which intelligent hot spots and intelligent tethering systems and methods such as those described herein may be incorporated. As illustrated, architecture 1100 of FIG. 12 includes a GSM core network 1101, a GPRS network 1130 and an IP multimedia network 1138. The GSM core network 1101 includes a Mobile Station (MS) 1102, at least one Base Transceiver Station (BTS) 1104 and a Base Station Controller (BSC) 1106. The MS 1102 is physical equipment or Mobile Equipment (ME), such as a mobile telephone or a laptop computer (e.g., mobile devices 210, 220, and 610) that is used by mobile subscribers, in one embodiment with a Subscriber identity Module (SIM). The SIM includes an International Mobile Subscriber Identity (IMSI), which is a unique identifier of a subscriber. The SIM may also include APNs. The BTS 1104 may be physical equipment, such as a radio tower, that enables a radio interface to communicate with the MS. Each BTS may serve more than one MS. The BSC 1106 may manage radio resources, including the BTS. The BSC may be connected to several BTSs. The BSC and BTS components, in combination, are generally referred to as a base station (BSS) or radio access network (RAN) 1103.

The GSM core network 1101 may also include a Mobile Switching Center (MSC) 1108, a Gateway Mobile Switching Center (GMSC) 1110, a Home Location Register (HLR) 1112, Visitor Location Register (VLR) 1114, an Authentication Center (AuC) 1118, and an Equipment Identity Register (EIR) 1116. The MSC 1108 may perform a switching function for the network. The MSC may also perform other functions, such as registration, authentication, location updating, handovers, and call routing. The GMSC 1110 may provide a gateway between the GSM network and other networks, such as an Integrated Services Digital Network (ISDN) or Public Switched Telephone Networks (PSTNs) 1120. Thus, the GMSC 1110 provides interworking functionality with external networks.

The HLR 1112 may be a database that may contain administrative information regarding each subscriber registered in a corresponding GSM network. Such information may include APNs and APN profiles. The HLR 1112 may also contain the current location of each MS. The VLR 1114 may be a database that contains selected administrative information from the HLR 1112. The VLR may contain information necessary for call control and provision of subscribed services for each MS currently located in a geographical area controlled by the VLR.

The HLR 1112 and the VLR 1114, together with the MSC 1108, may provide the call routing and roaming capabilities of GSM. The AuC 1116 may provide the parameters needed for authentication and encryption functions. Such parameters allow verification of a subscriber's identity. The EIR 1118 may store security-sensitive information about the mobile equipment.

A Short Message Service Center (SMSC) 1109 allows one-to-one short message service (SMS), or multimedia message service (MMS), messages to be sent to/from the MS 1102. A Push Proxy Gateway (PPG) 1111 is used to “push” (i.e., send without a synchronous request) content to the MS 1102. The PPG 1111 acts as a proxy between wired and wireless networks to facilitate pushing of data to the MS 1102. A Short Message Peer to Peer (SMPP) protocol router 1113 may be provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as voice, data, short message service (SMS), and multimedia message service (MMS), the MS may first register with the network to indicate its current location by performing a location update and IMSI attach procedure. MS 1102 may send a location update including its current location information to the MSC/VLR, via BTS 1104 and BSC 1106. The location information may then be sent to the MS's HLR. The HLR may be updated with the location information received from the MSC/VLR. The location update may also be performed when the MS moves to a new location area. Typically, the location update may be periodically performed to update the database as location updating events occur.

GPRS network 1130 may be logically implemented on the GSM core network architecture by introducing two packet-switching network nodes, a serving GPRS support node (SGSN) 1132, a cell broadcast and a Gateway GPRS support node (GGSN) 1134. The SGSN 1132 may be at the same hierarchical level as the MSC 1108 in the GSM network. The SGSN may control the connection between the GPRS network and the MS 1102. The SGSN may also keep track of individual MS's locations and security functions and access controls.

Cell Broadcast Center (CBC) 1133 may communicate cell broadcast messages that are typically delivered to multiple users in a specified area. Cell Broadcast is one-to-many geographically focused service. It enables messages to be communicated to multiple mobile telephone customers who are located within a given part of its network coverage area at the time the message is broadcast.

GGSN 1134 may provide a gateway between the GPRS network and a public packet network (PDN) or other IP networks 1136. That is, the GGSN may provide interworking functionality with external networks, and set up a logical link to the MS through the SGSN. When packet-switched data leaves the GPRS network, it may be transferred to an external TCP-IP network 1136, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services may be used in parallel. The MS may operate in one three classes: class A, class B, and class C. A class A MS may attach to the network for both GPRS services and GSM services simultaneously. A class A MS may also support simultaneous operation of GPRS services and GSM services. For example, class A mobiles may receive GSM voice/data/SMS calls and GPRS data calls at the same time.

A class B MS may attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

GPRS network 1130 may be designed to operate in three network operation modes (NOM1, NOM2 and NOM3). A network operation mode of a GPRS network may be indicated by a parameter in system information messages transmitted within a cell. The system information messages may direct an MS where to listen for paging messages and how to signal towards the network. The network operation mode represents the capabilities of the GPRS network. In a NOM1 network, a MS may receive pages from a circuit switched domain (voice call) when engaged in a data call. The MS may suspend the data call or take both simultaneously, depending on the ability of the MS. In a NOM2 network, a MS may not receive pages from a circuit switched domain when engaged in a data call, since the MS may be receiving data and may not be listening to a paging channel. In a NOM3 network, a MS may monitor pages for a circuit switched network while receiving data and vice versa.

The IP multimedia network 1138 was introduced with 3GPP Release 5, and may include IP multimedia subsystem (IMS) 1140 to provide rich multimedia services to end users.

A representative set of the network entities within IMS 1140 are a call/session control function (CSCF), a media gateway control function (MGCF) 1146, a media gateway (MGW) 1148, and a master subscriber database, called a home subscriber server (HSS) 1150. HSS 1150 may be common to GSM core network 1101, GPRS network 1130 as well as IP multimedia network 1138. Examples of HSS 1150 may include servers 250 and 650.

IP multimedia system 1140 may be built around the call/session control function, of which there are three types: an interrogating CSCF (I-CSCF) 1143, a proxy CSCF (P-CSCF) 1142, and a serving CSCF (S-CSCF) 1144. The P-CSCF 1142 is the MS's first point of contact with the IMS 1140. The P-CSCF 1142 may forward session initiation protocol (SIP) messages received from the MS to an SIP server in a home network (and vice versa) of the MS. The P-CSCF 1142 may also modify an outgoing request according to a set of rules defined by the network operator (for example, address analysis and potential modification).

I-CSCF 1143 forms an entrance to a home network and hides the inner topology of the home network from other networks and provides flexibility for selecting an S-CSCF. I-CSCF 1143 may contact subscriber location function (SLF) 1145 to determine which HSS 1150 to use for the particular subscriber, if multiple HSSs 1150 are present. S-CSCF 1144 may perform the session control services for MS 1102. This includes routing originating sessions to external networks and routing terminating sessions to visited networks. S-CSCF 1144 may also decide whether an application server (AS) 1152 is required to receive information on an incoming SIP session request to ensure appropriate service handling. This decision may be based on information received from HSS 1150 (or other sources, such as application server 1152). AS 1152 may also communicate to location server 1156 (e.g., a Gateway Mobile Location Center (GMLC)) that provides a position (e.g., latitude/longitude coordinates) of MS 1102.

HSS 1150 may contain a subscriber profile, including tethered device profiles, and keep track of which core network node is currently handling the subscriber. It may also support subscriber authentication and authorization functions (AAA). In networks with more than one HSS 1150, a subscriber location function provides information on the HSS 1150 that contains the profile of a given subscriber.

MGCF 1146 may provide interworking functionality between SIP session control signaling from the IMS 1140 and ISUP/BICC call control signaling from the external GSTN networks (not shown.) It may also control the media gateway (MGW) 1148 that provides user-plane interworking functionality (e.g., converting between AMR- and PCM-coded voice.) MGW 1148 may also communicate with other IP multimedia networks 1154.

Push to Talk over Cellular (PoC) capable mobile telephones may register with the wireless network when the telephones are in a predefined area (e.g., job site, etc.) When the mobile telephones leave the area, they may register with the network in their new location as being outside the predefined area. This registration, however, does not indicate the actual physical location of the mobile telephones outside the pre-defined area.

While example embodiments of intelligent hot spots and intelligent tethering systems and methods have been described in connection with various communications devices and computing devices/processors, the underlying concepts can be applied to any communications or computing device, processor, or system capable of implementing the dynamic bearer management systems and methods described. The various techniques described herein may be implemented in connection with hardware or software or, where appropriate, with a combination of both. Thus, the intelligent hot spots and intelligent tethering systems and methods, or certain aspects or portions thereof, can take the form of program code (i.e., instructions) embodied in tangible and/or non-transitory media, such as floppy diskettes, CD-ROMs, hard drives, or any other machine-readable storage medium, wherein, when the program code is loaded into and executed by a machine, such as a computer, the machine becomes an apparatus for providing an intelligent hot spot and/or intelligent tethering. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

Intelligent hot spots and intelligent tethering systems and methods may also be practiced via communications embodied in the form of program code that is transmitted over some transmission medium, such as over electrical wiring or cabling, through fiber optics, or via any other form of transmission, wherein, when the program code is received, loaded into, and executed by a machine, such as an EPROM, a gate array, a programmable logic device (PLD), a client computer, or the like, the machine becomes an apparatus for providing an intelligent hot spot and/or intelligent tethering. When implemented on a general-purpose processor, the program code combines with the processor to provide a unique apparatus that operates to invoke the functionality of an intelligent hot spot and/or intelligent tethering as described herein. Additionally, any storage techniques used in connection with an intelligent hot spot and/or intelligent tethering system may invariably be a combination of hardware and software.

While intelligent hot spots and intelligent tethering systems and methods have been described in connection with the various embodiments of the various figures, it is to be understood that other similar embodiments may be used or modifications and additions may be made to the described embodiments for performing the same function of providing an intelligent hot spot and/or intelligent tethering without deviating therefrom. For example, one skilled in the art will recognize intelligent hot spots and intelligent tethering as described in the present application may apply to any environment, whether wired or wireless, and may be applied to any number of such devices connected via a communications network and interacting across the network. Therefore, systems and methods for providing an intelligent hot spot and intelligent tethering should not be limited to any single embodiment, but rather should be construed in breadth and scope in accordance with the appended claims.

What is claimed is:

1. A method comprising:
receiving a first request for access to a long term evolution (LTE) network from a first wireless device;
responsive to receiving the first request, determining a ranking for each wireless device from a plurality of wireless devices from which requests for access to the LTE network have been received, wherein the plurality of wireless devices comprises the first wireless device;
determining that the first wireless device is a highest ranked wireless device from among the plurality of wireless devices; and
transmitting connection information to the first wireless device.

2. The method of claim 1, wherein determining that the first wireless device is the highest ranked wireless device from among the plurality of wireless devices comprises:
soliciting bids from the plurality of wireless devices;
receiving the bids from the plurality of wireless devices; and
determining that a bid received from the first wireless device is a highest bid from among the received bids.

3. The method of claim 1, wherein determining that the first wireless device is the highest ranked wireless device from among the plurality of wireless devices comprises determining that the first wireless device has a highest priority from among the plurality of wireless devices.

4. The method of claim 1, wherein determining that the first wireless device is the highest ranked wireless device from among the plurality of wireless devices comprises determining that the first wireless device has accessed the LTE network more recently than any other device from among the plurality of wireless devices.

5. The method of claim 1, further comprising, responsive to receiving the first request, determining that a number of devices currently being serviced exceeds a predetermined threshold.

6. The method of claim 1, further comprising:
after transmitting the connection information to the first wireless device, determining that other requests for access to the LTE network have been received from other wireless devices from among the plurality of wireless devices;
determining that the other wireless devices are not currently being provided access to the LTE network; and
determining a ranking for each of the other wireless devices.

7. The method of claim 1, further comprising, responsive to receiving the first request, determining that current bandwidth utilization exceeds a predetermined threshold.

8. A network device comprising:
a transceiver configured to:
receiving a first request for access to a long term evolution (LTE) network from a first wireless device, and
transmit connection information to the first wireless device; and
a processor configured to:
responsive to receiving the first request, determine a ranking for each wireless device from a plurality of wireless devices from which requests for access to the LTE network have been received, wherein the plurality of wireless devices comprises the first wireless device, and
determine that the first wireless device is a highest ranked wireless device from among the plurality of wireless devices.

9. The network device of claim 8, wherein the first request comprising identification information for the first wireless device, and wherein the transceiver is further configured to transmit the identification information for the first wireless device to the LTE network.

10. The network device of claim 8, wherein the first request comprising identification information for a type of the first wireless device, and wherein the transceiver is further configured to transmit the identification information for the type of the first wireless device to the LTE network.

11. The network device of claim 8, wherein the processor is configured to determine that the first wireless device is the highest ranked wireless device from among the plurality of wireless devices by determining that the first wireless device has accessed the LTE network less recently than any other device from among the plurality of wireless devices.

12. The network device of claim 8, wherein the processor is configured to determine that the first wireless device is the highest ranked wireless device from among the plurality of wireless devices by determining that the first wireless device has used more bandwidth than any other device from among the plurality of wireless devices.

13. The network device of claim 8, wherein the processor is configured to determine that the first wireless device is the highest ranked wireless device from among the plurality of wireless devices by determining that the first wireless device has used less bandwidth than any other device from among the plurality of wireless devices.

14. The network device of claim 8, wherein the processor is configured to determine that the first wireless device is the highest ranked wireless device from among the plurality of wireless devices by determining that a type of the first wireless device is a highest ranked type from among types of each of the plurality of wireless devices.

15. A computer-readable medium comprising instructions for:
receiving a first request for access to a long term evolution (LTE) network from a first wireless device;
responsive to receiving the first request, determining a ranking for each wireless device from a plurality of wireless devices from which requests for access to the LTE network have been received, wherein the plurality of wireless devices comprises the first wireless device;
determining that the first wireless device is a highest ranked wireless device from among the plurality of wireless devices; and
transmitting connection information to the first wireless device.

16. The computer-readable medium of claim 15, further comprising instructions for:
generating a web page comprising a solicitation of bids for access to the LTE network; and
transmitting the web page to the plurality of wireless devices.

17. The computer-readable medium of claim 16, wherein the web page comprises an indication of a minimum bid amount.

18. The computer-readable medium of claim 16, wherein the web page comprises an indication of an amount of bandwidth to be provided for the access to the LTE network.

19. The computer-readable medium of claim 15, further comprising instructions for determining that a capacity to provide access to the LTE network of a computing device executing the instructions is approaching a maximum capacity

20. The computer-readable medium of claim 15, further comprising instructions for:
determining a next highest ranked wireless device from among the plurality of wireless devices; and
transmitting second connection information to the next highest ranked wireless device.
